(19) United States
(12) Patent Application Publication
(10) Pub. No.: US 2018/0200801 A1
(43) Pub. Date: Jul. 19, 2018

(54) Preparation Method for the Nano-silver Particles

(71) Applicants: Shenzhen Guohua Optoelectronics Co., Ltd., Shenzhen (CN); Academy of Shenzhen Guohua Optoelectronics, Shenzhen (CN); G.H.S Advanced Equipment Technology Co.,Ltd., Shenzhen (CN)

(72) Inventors: Guofu ZHOU, Shenzhen (CN); Nan LI, Shenzhen (CN); Lingling SHUI, Guangzhou (CN); Mingliang JIN, Guangzhou (CN)

(73) Assignees: Shenzhen Guohua Optoelectronics Co., Ltd., Shenzhen (CN); Academy of Shenzhen Guohua Optoelectronics, Shenzhen (CN); G.H.S Advanced Equipment Technology Co.,Ltd., Shenzhen (CN)

(21) Appl. No.: 15/531,738

(22) PCT Filed: May 18, 2016
(86) PCT No.: PCT/CN2016/082432

§ 371 Date: May 31, 2017

(51) Int. Cl. B22F 9/24; B22F 1/00

(52) U.S. Cl. CPC B22F 9/24; B22F 1/0018; B22F 2202/17; B22F 2202/05; B82Y 40/00; B22F 2301/255; B22F 2304/054; B22F 2304/056; B22F 2202/06

(57) ABSTRACT

present invention relates to a technical field of nano-silver particles, and discloses a preparation method for nano-silver particles. The preparation method includes following steps: 1) silver nitrate and water soluble stabilizer are weighed and put into a reaction vessel; 2) water is added into the reaction vessel; 3) in an illuminated environment at room temperature under atmospheric pressure, the solution in the reaction vessel is electromagnetically stirred until the solution in the reaction vessel turns red, and the nano-silver particles are formed in the solution; 4) after the reaction of the solution in the reaction vessel in step 3), the reaction vessel with the solution is kept out of light and the nano-silver particles are then extracted from the solution.

### CROSS REFERENCE TO RELATED APPLICATIONS

This application is the national phase entry of International Application No. PCT/CN2016/082432, filed on May 18, 2016, the entire contents of which are incorporated herein by reference.

### TECHNICAL FIELD

The present invention relates to a technical field of nano-silver particles, in particular to a preparation method for the nano-silver particles.

### BACKGROUND

The metal silver is an element with stable chemical properties and excellent physical properties. With good electrical and thermal conductivities, the metal silver is widely used in the industry. Compared to macroscopic block material, the nanometer material has an unique physicochemical property Meanwhile, with the tendency of developing integrated and miniaturized electronic devices, the synthesis of materials is impelled to develop toward the direction of nanoscale.

Nano-silver material is widely used in the fields of optics, electricity, catalyzing, biological material, etc., because of both excellent physicochemical properties itself and special properties showed by nanoscale. Additionally, an extensive research, related to eliminate bacteria and poison by the nano-silver particles, shows that the nano-silver particles have a broad prospect in medical field and has an inestimable prospect in treating human diseases in the future. Moreover, researches in the fields of food preservation and wastewater treatment are expanded with the properties of eliminate bacteria and poison of the nano-silver particles.

In prior art, there are three main preparation categories for the nano-silver particles at present, i.e., a chemical method, a physical method, and a biological method.

When chemical method is used to prepare the nano-silver particles, a reducing agent is employed to reduce silver salt precursor, and a stabilizer is added to disperse the prepared nano-silver particles to prevent the nano-silver particles from clustering, wherein the mainly used reducing agent is inorganic reducing agent, such as hydrazine, sodium borohydride, etc. The chemical method mainly includes methods of chemical-reduction, electrochemistry, irradiation assisted chemical reduction, and pyrolysis, etc. The chemical method requires to introduce a reducing agent, which results in a complex preparation process and a high cost.

It is unnecessary for the physical method of preparing nano-silver particles, including methods of ball milling, arc-discharge synthesis, and DC magnetron sputtering, etc., to introduce various chemical reagents. The physical method has an advantage of friendly environment, and a disadvantage of considerable energy consumption in the preparing process, and easily clustering of the obtained nano-silver particles, which results in a limitation in the application of the physical method.

Plant extract or microbe is adopted to reduce and obtain the nano-silver particles when the nano-silver particles are synthesized by the biological method. The key point to apply biological method is whether a proper plant extract is obtained or a proper microbe is chosen. The drawback of the biological method is that a lack of raw material for preparation leads to a difficult large-scale production.

### SUMMARY OF THE INVENTION

The purpose of the present invention is to provide a preparation method for nano-silver particles and aims to solve the issues of a complex preparing process, a high cost, a high energy consumption, and a difficult large-scale production in preparation methods for nano-silver particles in the prior art.

The preparation method for nano-silver particles in the present invention is achieved by following steps:

1) Silver nitrate and water soluble stabilizer are weighed and put into a reaction vessel.

2) Water is added into the reaction vessel.

3) In an illuminated environment, at room temperature, under atmospheric pressure, the solution in the reaction vessel is electromagnetically stirred until the solution in the reaction vessel turns red, and the nano-silver particles are formed in the solution.

4) After the reaction of the solution in the reaction vessel in step 3), the reaction vessel with the solution is kept out of light and the nano-silver particles are then extracted from the solution.

Compared to the prior art, the above preparation method for nano-silver particles has advantages as below:

1) Besides silver nitrate and stabilizer, it is unnecessary to introduce any reducing agent and any other chemical reagents, thus no by-product is produced and is environment friendly. Moreover, the whole preparing process is simple and of low cost.

2) During the preparing process, other devices are unnecessary, except that the solution in the reaction vessel is stirred. Thus, the operations are easy, convenient, and economic.

3) The preparing process is operated in room temperature, thus the energy consumption is lower.

4) The preparing time is short, thus the preparation method is fast and convenient.

### BRIEF DESCRIPTION OF THE DRAWINGS

FIG. 1 is an experimental schematic diagram of the nano-silver particles obtained by the preparation method for nano-silver particles provided by Embodiment 1 of the present invention.

FIG. 2 is an experimental schematic diagram of the nano-silver particles obtained by the preparation method for nano-silver particles provided by Embodiment 2 of the present invention.

FIG. 3 is an experimental schematic diagram of the nano-silver particles obtained by the preparation method for nano-silver particles provided by Embodiment 3 of the present invention.

FIG. 4 is an experimental schematic diagram of the nano-silver particles obtained by the preparation method for nano-silver particles provided by Embodiment 4 of the present invention.

FIG. 5 is an experimental schematic diagram of the nano-silver particles obtained by the preparation method for nano-silver particles provided by Embodiment 5 of the present invention.

FIG. 6 is an experimental schematic diagram of a composite material which is obtained by being absorbed by activated carbon after synthesis of the nano-silver particles provided by the embodiments of the present invention.

FIG. 7 is an experimental schematic diagram of a sample of the nano-silver aqueous solution provided by the embodiments of the present invention.

### DETAILED DESCRIPTION OF THE INVENTION

To make the purpose, technical solutions, and advantages of the present invention more definite and clear, the present invention is further described in detail, with reference to the drawings and embodiments. It should be understood that the specific embodiments described hereinafter are only illustrative of the present invention, and are not used to limit the present invention.

The implementations of the present invention are described in detail hereinafter, with reference to specific embodiments.

### Embodiment 1

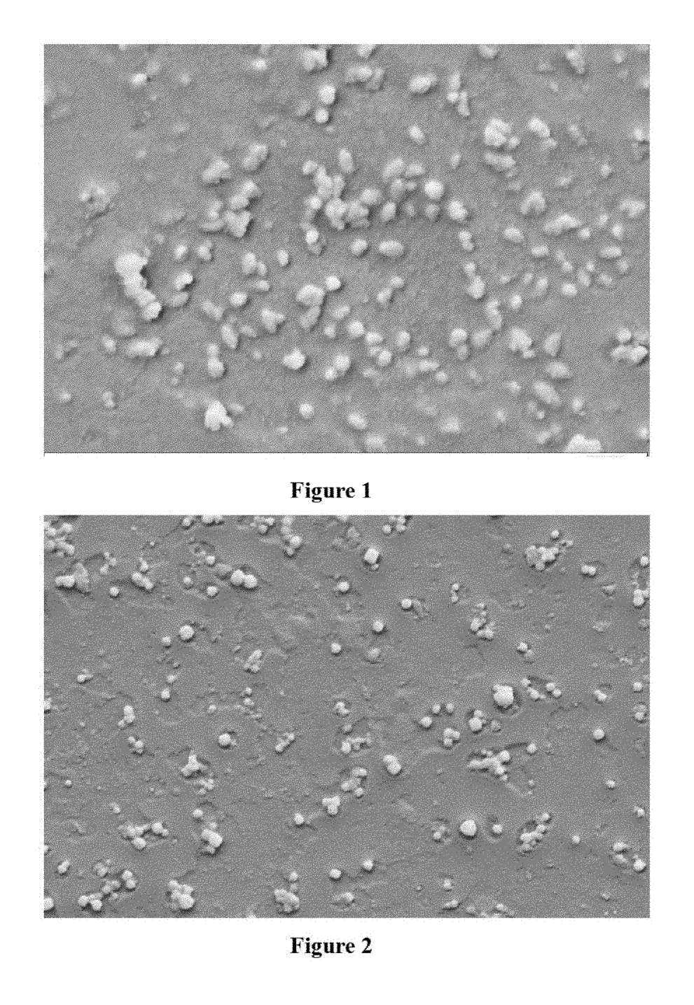

Referring to FIG. 1, a preferred embodiment of the present invention is provided.

The preparation method for nano-silver particles provided by this embodiment, includes following steps:

1) Silver nitrate (AgNO₃) and water soluble stabilizer are weighed and put into a reaction vessel, such as a beaker, etc.

2) Water is added into the reaction vessel.

3) In an illuminated environment, at room temperature, under atmospheric pressure, the solution in the reaction vessel is electromagnetically stirred until the solution in the reaction vessel turns red, namely the nano-silver particles are formed in the solution.

4) After the reaction of the solution in the reaction vessel in step 3), the reaction vessel with the solution is kept out of light and the nano-silver particles are extracted from the solution.

In the above preparation method for nano-silver particles, water is the only solvent. Silver nitrate is matched with a proper stabilizer, as well as a proper illuminated environment at room temperature under atmospheric pressure. The solution is then electromagnetically stirred to obtain nano-silver particles. Next the method of dark storage is utilized and the nano-silver particles in the solution are extracted. Without heating the reducing agent in this preparation method, the whole preparing process is simplified, the cost is lowered, and the energy consumption is reduced. In addition, the raw material of this preparation method is easily obtainable, thus there is no lack of raw material and the large-scale production can be achieved.

The above preparation method for nano-silver particles has advantages as below:

1) Besides silver nitrate and stabilizer, it does not require any reducing agent and any other chemical reagents, thus no by-product is produced arid the method is environment friendly. Moreover, the whole preparing process is simple and of low cost.

2) During the preparing process, other devices are unnecessary, except that the solution in the reaction vessel is stirred. Thus, the operations are easy, convenient, and economic.

3) The preparing process is operated at room temperature: thus the energy consumption is less.

4) The preparing time is short thus the preparation method is fast and convenient.

Moreover, compared to the conventional preparation methods, the above preparation method for nano-silver particles has a potential of large-scale production in industry and incomparable advantages in raw material selection, energy consumption, practical operation skills of synthesis, economic investment, and time period of synthesis. Meanwhile, the synthesized nano-silver particles are dissolved in aqueous solution, thus the follow-up experiments and researches can directly proceed in some fields, such as medical field, and certain conveniences are also provided for studies in other fields.

Specifically, the above water soluble stabilizer is polyvinyl pyrrolidone (PVP) or polyethylene glycol (PEG) or polyethylene oxide (PEO) or polyvinyl alcohol (PVA), etc. Further, in step 1), the molar ratio range of silver nitrate to stabilizer is 1:1˜1:10.

If the stabilizer in step 1) is PVP, the silver nitrate and the PVP can be mixed in the reaction vessel at the same time, and then water is added into the reaction vessel. However, if the stabilizer is PEG or PEO or PVA, it is required that the stabilizer should be dissolved in the water first to form a stabilizer solution, and then the stabilizer solution and the silver nitrate are mixed in the reaction vessel.

In step 2), the water added into the reaction vessel can be ordinary tap water, etc., and the amount of water depends on the silver nitrate and stabilizer in the reaction vessel. Generally, the amount of water is controlled to fall within the range of 10 ml˜50 ml.

In step 3), the reaction vessel is continually stirred on the platform of an electromagnetic stirrer. After stirring for a period of time, the solution in the reaction vessel will firstly form into a uniform and transparent solution. As the reaction proceeds, the color of the solution will gradually turn into slight red, namely the nano-silver particles have already been generated. As the stirring time goes on, the color of the solution will gradually and further deepen.

In the above stirring, the reaction vessel can be put on the platform of an electromagnetic stirrer to be automatically stirred. Further, the solution in the reaction vessel can also certainly be stirred by other stirring devices, etc.

Furthermore, in the above step 3, the reaction time of stirring can be controlled within the range of 8 min-10 h, according to the size requirement of nano-silver particles. In addition, the nano-silver particles of different sizes can be obtained by controlling the reaction environment or adjusting the reaction duration.

In step 4), the nano-silver particles in the solution, which is kept out of the light, can be extracted by a method of centrifuging or absorbing with absorbing material.

Referring to FIG. 1, in a practical operation, the nano-silver particles of sizes within a range of 50 nm↦150 nm can be obtained as illustrated in the following example.

The silver nitrate of 16.8 mg and the PVP (Mr ˜10000) of 33.4 mg are weighed, and the molar ratio of silver nitrate to the PVP is about 1:3. Then the silver nitrate and the PVP are put into a reaction vessel (such as a beaker) with a capacity of 50 ml. The 20 ml of water is added into the reaction vessel and the solution is electromagnetically stirred in an environment with natural light for 6 h. The silver nitrate and the PVP are both water soluble, and are both formed into a uniform and transparent solution after being stirred for 5 mins. If keeping stirring, the solution will gradually turn from the uniform and transparent solution into a transparent solution in slight red. As the time passes by, the solution will finally become an amaranthine solution with nano-silver particles and the obtained solution is kept out of light.

### Embodiment 2

The differences between this embodiment and Embodiment 1 are provided: Referring to FIG. 2, a schematic diagram of nano-silver particles obtained by this embodiment is shown.

The silver nitrate of 17.4 mg and the PVP (Mr ˜10000) of 55.4 mg are weighed, and the molar ratio of silver nitrate to the PVP is about 1:5. The 20 ml of water is added and the solution is electromagnetically stirred and sufficiently dissolved in an environment with natural light. The silver nitrate and the PVP are both formed into a transparent solution after being dissolved in the water. After reacting for several minutes, the solution will start to turn into slight red. As the stirring time goes on, the color of the solution gradually deepens. After the reaction continued for 1.5 h, the solution with nano-silver particles will be obtained and the obtained solution is kept out of light.

### Embodiment 3

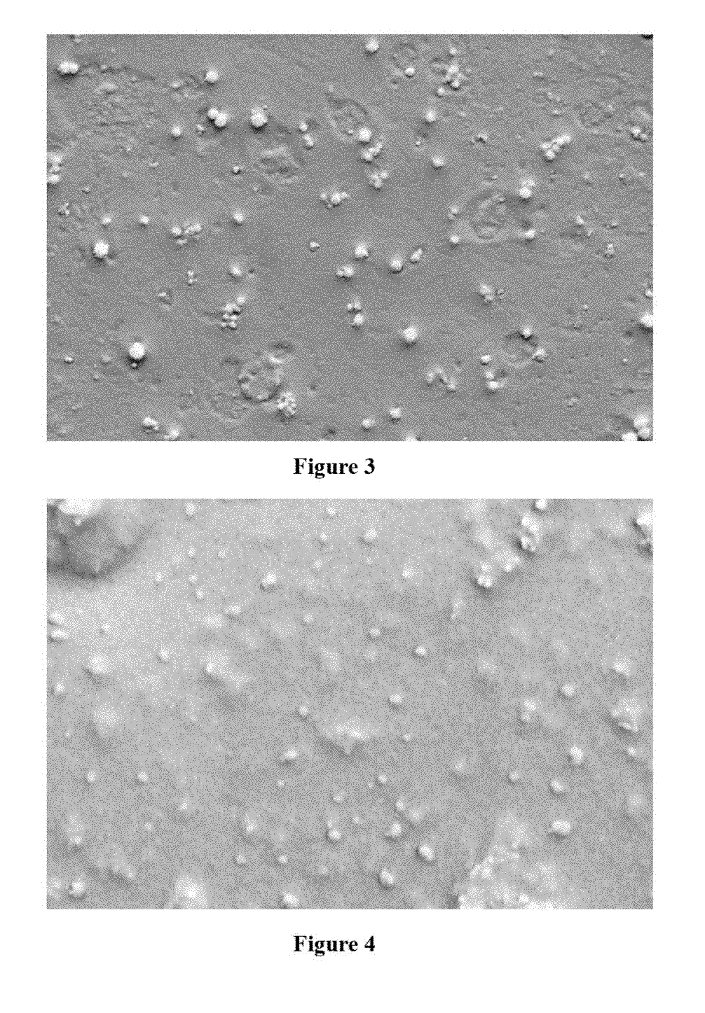

The differences between this embodiment and Embodiment 1 are provided: Referring to FIG. 3, a schematic diagram of nano-silver particles obtained by this embodiment is shown.

The silver nitrate of 17.2 mg and the (Mr ˜10000) of 77.8 mg are weighed, and the molar ratio of the silver nitrate to the PVP is about 1:7. The silver nitrate and the PVP are added into the reaction vessel at the same time, then the 20 ml of water is added. The solution is sufficiently stirred in an environment with natural light to form a transparent solution. After reacting for several minutes, the solution will start to turn into slight red. After the reaction controlled to continue for 30 mins, the solution with nano-silver particles will be obtained and the obtained solution is kept out of light.

### Embodiment 4

The differences between this embodiment and Embodiment 1 are provided: Referring to FIG. 4, a schematic diagram of nano-silver particles obtained by this embodiment is shown.

The silver nitrate of 17.6 mg and the PVA (MR ˜145000) of 13.0 mg are weighed, and the molar ratio of the silver nitrate to the. PVA is about 1:3. First, the PVA is dissolved in the water to form a colorless and transparent solution. Then the weighed silver nitrate is added into the reaction vessel and the 20 ml of water is added. The solution is electromagnetically stirred in an environment with natural light. After the solution being stirred for 30 mins, a solution in slight red will be obtained and the obtained solution is kept out of light.

### Embodiment 5

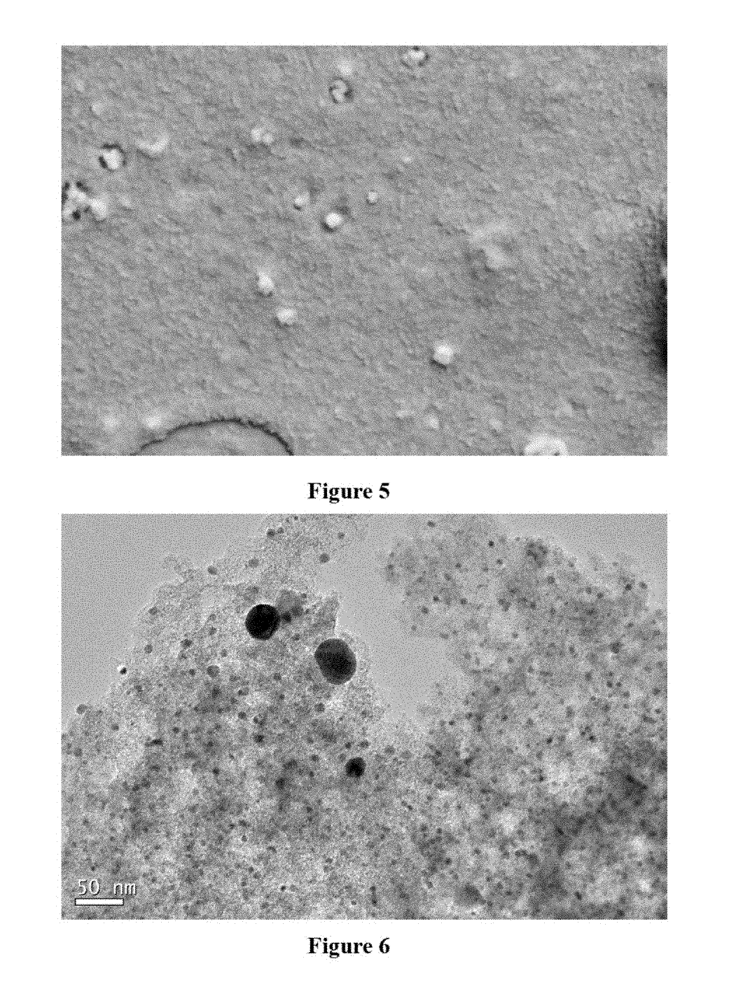

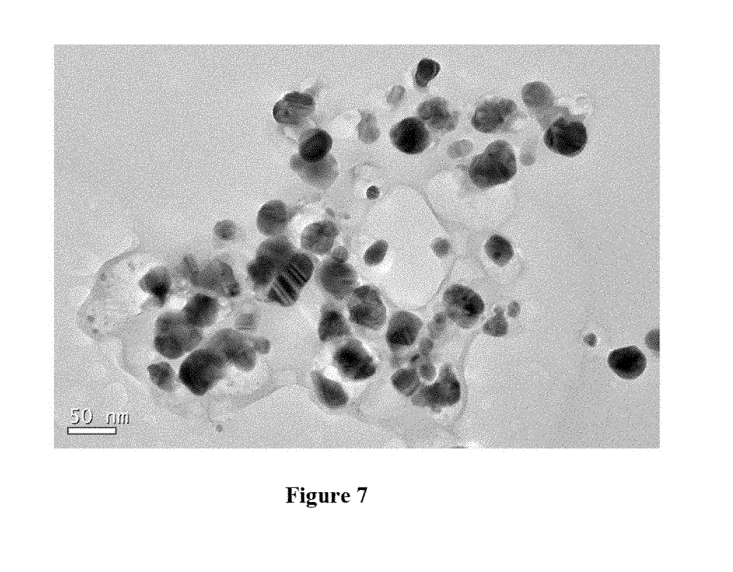

The differences between this embodiment and Embodiment 1 are provided: Referring to FIG. 5, a schematic diagram of nano-silver particles obtained by this embodiment is shown.

The silver nitrate of 17.1 mg and the PVA (Mr ˜145000) of 22.3 mg are weighed, and the molar ratio of the silver nitrate to the PVA is about 1:5. The weighed reagent is put into the reaction vessel and the 20 ml of water is added. The solution is electromagnetically stirred in an environment with natural light. After the solution being stirred for 30 mins, a solution in slight red will be obtained and the obtained solution is kept out of light.

The above description is only illustrative of some preferred embodiments of the present invention, and will not be used to limit the present invention. Any modification, equivalent replacement, and improvement, within the spirit and principles of the present invention, will all fall into the protective scope of the present invention.

What is claimed is:

1. A preparation method for nano-silver particles, comprising following steps:
1) weighing silver nitrate and a water soluble stabilizer and putting the silver nitrate and the water soluble stabilizer into a reaction vessel;
2) adding water into the reaction vessel;
3) in an illuminated environment at a room temperature under an atmospheric pressure, electromagnetically stirring a solution in the reaction vessel until the solution in the reaction vessel turns red, and firming the nano-silver particles in the solution;
4) after a reaction of the solution in the reaction vessel in step 3), keeping the reaction vessel with the solution out of light and extracting the nano-silver particles from the solution.

2. The preparation method for nano-silver particles of claim 1, wherein the stabilizer is polyvinyl pyrrolidone (PVP) or polyethylene glycol (PEG) or polyethylene oxide (PEO) or polyvinyl alcohol (PVA).

3. The preparation method for nano-silver particles of claim 1, wherein a molar ratio range of the silver nitrate to the stabilizer is 1:1˜1:10.

4. The preparation method for nano-silver particles of claim 1, wherein in the step 3), the reaction vessel is put on a platform of an electromagnetic stirrer and the solution in the reaction vessel is electromagnetically stirred.

5. The preparation method for nano-silver particles of claim 1, wherein in the step 3), stirring time of the solution in the reaction vessel is controlled within the range of 8 min-10 h.

6. The preparation method for nano-silver particles according to claim 1, wherein in the step 4), the nano-silver particles in the reaction vessel are extracted by a centrifugal method.

7. The preparation method for nano-silver particles according to claim 1, wherein in the step 4), the nano-silver particles in the reaction vessel are absorbed by an absorbing material.

8. The preparation method for nano-silver particles according to claim 1, wherein the stabilizer is polyethylene glycol (PEG) or polyethylene oxide (PEO) or polyvinyl alcohol (PVA), and in the step 1), first dissolving the stabilizer in the water to form a stabilizer solution, then putting the silver nitrate and the stabilizer solution into the reaction vessel.

9. The preparation method for nano-silver particles according to claim 1, wherein the stabilizer is polyvinyl pyrrolidone (PVP), in the step 1), mixing the silver nitrate and the polyvinyl pyrrolidone (PVP) and putting a mixture into the reaction vessel.

10. The preparation method for nano-silver particles according to claim 2, wherein in the step 4), the nano-silver particles in the reaction vessel are extracted by a centrifugal method.

11. The preparation method for nano-silver particles according to claim 3, wherein in the step 4), the nano-silver particles in the reaction vessel are extracted by a centrifugal method.

12. The preparation method for nano-silver particles according to claim 4, wherein in the step 4), the nano-silver particles in the reaction vessel are extracted by a centrifugal method.

13. The preparation method for nano-silver particles according to claim 2, wherein in the step 4), the nano-silver particles in the reaction vessel are absorbed by an absorbing material.

14. The preparation method for nano-silver particles according to claim 3, wherein in the step 4), the nano-silver particles in the reaction vessel are absorbed by an absorbing material.

15. The preparation method for nano-silver particles according to claim 4, wherein in the step 4), the nano-silver particles in the reaction vessel are absorbed by an absorbing material.

16. The preparation method for nano-silver particles according to claim 2, wherein the stabilizer is polyethylene glycol (PEG) or polyethylene oxide (PEO) or polyvinyl alcohol (PVA), and in the step 1), first dissolving the stabilizer in the water to form a stabilizer solution, then putting the silver nitrate and the stabilizer solution into the reaction vessel.

17. The preparation method for nano-silver particles according to claim 3, wherein the stabilizer is polyethylene glycol (PEG) or polyethylene oxide (PEO) or polyvinyl alcohol (PVA), and in the step 1), first dissolving the stabilizer in the water to form a stabilizer solution, then putting the silver nitrate and the stabilizer solution into the reaction vessel.

18. The preparation method for nano-silver particles according to claim 4, wherein the stabilizer is polyethylene glycol (PEG) or polyethylene oxide (PEO) or polyvinyl alcohol (PVA), and in the step 1), first dissolving the stabilizer in the water to form a stabilizer solution, then putting, the silver nitrate and the stabilizer solution into the reaction vessel.

19. The preparation method for nano-silver particles according to claim 2, wherein the stabilizer is polyvinyl pyrrolidone (PVP), in the step 1), mixing the silver nitrate and the polyvinyl pyrrolidone (PVP) and putting a mixture into the reaction vessel.

20. The preparation method for nano-silver particles according to claim 3, wherein the stabilizer is polyvinyl pyrrolidone (PVP), in the step 1), mixing the silver nitrate and the polyvinyl pyrrolidone (PVP) and putting. a mixture into the reaction vessel.
